(19) United States
(12) Patent Application Publication
(10) Pub. No.: US 2026/0046447 A1
(43) Pub. Date: Feb. 12, 2026

(54) INTRA PREDICTION BASED ON MULTIPLE REFERENCE LINES

(71) Applicant: MEDIATEK INC., Hsinchu City (TW)

(72) Inventors: Man-Shu CHIANG, Hsinchu City (TW); Tzu-Der CHUANG, Hsinchu City (TW); Ching-Yeh CHEN, Hsinchu City (TW); Chih-Wei HSU, Hsinchu City (TW)

(21) Appl. No.: 18/997,631

(22) PCT Filed: Jul. 17, 2023
(86) PCT No.: PCT/CN2023/107652

§ 371 Date: Jan. 22, 2025

Related U.S. Application Data
(60) Provisional application No. 63/369,773, filed on Jul. 29, 2022.
(60) Provisional application No. 63/380,395, filed on Oct. 21, 2022.

(51) Int. Cl. H04N 19/593; H04N 19/105; H04N 19/11; H04N 19/117; H04N 19/132; H04N 19/172; H04N 19/176; H04N 19/182; H04N 19/80

(52) U.S. Cl. CPC H04N 19/593; H04N 19/105; H04N 19/11; H04N 19/117; H04N 19/132; H04N 19/172; H04N 19/176; H04N 19/182; H04N 19/80

(57) ABSTRACT

A method for using multiple reference lines to perform intra-prediction of a block of pixels is provided. A video coder receives data for a block of pixels to be encoded or decoded as a current block of a current picture of a video. The video coder receives or signals a selection of first and second reference lines among a plurality of reference lines that neighbor the current block. The video coder blends samples of first and second reference lines, each blended sample generated by combining a sample in the first reference line with a sample in the second reference line that is identified according to an intra-prediction mode. The video coder generates a prediction of the current block with the intra-prediction mode by using the blended samples. The video coder encodes or decodes the current block by using the generated prediction.

### CROSS REFERENCE TO RELATED PATENT APPLICATION(S)

The present disclosure is part of a non-provisional application that claims the priority benefit of U.S. Provisional Patent Application Nos. 63/369,773 and 63/380,395, filed on 29 Jul. 2022 and 21 Oct. 2022, respectively. Contents of above-listed applications are herein incorporated by reference.

### TECHNICAL FIELD

The present disclosure relates generally to video coding. In particular, the present disclosure relates to methods of coding pixel blocks by intra-prediction.

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one-color component associated with CTU, CU, PU, and TU, respectively. Thus, a CTU consists of one luma CTB, two chroma CTBs, and associated syntax elements. A similar relationship is valid for CU, PU, and TU.

For each inter-predicted CU, motion parameters consisting of motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signalled explicitly per each CU.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

A method for using multiple reference lines to perform intra-prediction of a block of pixels is provided. A video coder receives data for a block of pixels to be encoded or decoded as a current block of a current picture of a video. The video coder receives or signals a selection of first and second reference lines among a plurality of reference lines that neighbor the current block. The video coder blends samples of first and second reference lines, each blended sample generated by combining a sample in the first reference line with a sample in the second reference line that is identified according to an intra-prediction mode. The video coder generates a prediction of the current block with the intra-prediction mode by using the blended samples. The video coder encodes or decodes the current block by using the generated prediction.

In some embodiments, when the intra prediction mode is an intra prediction direction, a location of a to-be-blended sample in the first reference line and a location of a to-be-blended sample in the second reference line follow the direction of the intra prediction mode; when the intra prediction mode is not an intra prediction direction, (e.g., DC or planar) a location of a to-be-blended sample in the first reference line and a location of a to-be-blended sample in the second reference line are the same.

In some embodiments, the samples in the first reference line being blended may be samples of a top reference line section or a left reference line section of the first reference line. The top reference line section of the first reference line may be identified by a first line index and a top reference line section of the second reference line may be identified by a second line index. In addition, the left reference line section of the first reference line may be identified by the first line index and a left reference line section of the second reference line may be identified by the second line index. In some embodiments, the first reference line index is explicitly signaled and the second reference line index is signaled by an explicitly signaled offset relative to the first line index.

In some embodiments, the encoder may apply an interpolation filter (e.g., a 4-tap filter) to a blended sample when the blended sample is located at a non-integer position (e.g., due to the intra-prediction direction). In some embodiments, the encoder applies a first interpolation filter to a sample in the first reference line to be blended (sample-to-be-blended) when the sample is located at a non-integer position. The encoder may also apply a second interpolation filter to a sample in the second reference line to be blended when the sample is located at a non-integer position. The first and second interpolation filters may be same or different (in terms of e.g., filter taps).

In some embodiments, the prediction is generated by using the blended sample when an explicit flag enables a particular tool that uses samples from multiple reference lines for intra-prediction. In some embodiments, the prediction is generated by using the blended samples only when an explicit flag enables a particular tool that uses samples from multiple reference lines. In some embodiments, a blended sample is not used to generate the prediction of the current block when a difference between the samples of the first and second reference lines used to create the blended sample fails to meet a particular criterion (e.g., the difference ≥threshold or <threshold.) In some embodiments, whether to blend samples of first and second reference lines is determined based on an implicit indication based on e.g., block width, height, or area of the current block.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 shows the intra-prediction modes in different directions.

FIGS. 2A-B conceptually illustrate top and left reference templates with extended lengths for supporting wide-angular direction mode for non-square blocks of different aspect ratios.

FIG. 3 conceptually illustrates reference lines of a current block that can be used for intra prediction of the current block.

FIG. 4 shows top and left reference line sections that provide samples to be blended for intra prediction.

FIG. 5 illustrates blending reference lines based on an intra prediction mode of the current block.

FIG. 6 illustrates an example video encoder 600 that implement intra-prediction.

FIG. 7 illustrate portions of the video encoder 600 that implement intra-predictions by blending multiple reference lines.

FIG. 8 conceptually illustrates a process that performs intra-prediction by blending multiple reference lines.

FIG. 9 illustrates an example video decoder that implement intra prediction.

FIG. 10 illustrate portions of the video decoder that implement intra-predictions by blending multiple reference lines.

FIG. 11 conceptually illustrates a process that performs intra-prediction by blending multiple reference lines.

FIG. 12 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### 1. Intra Prediction Modes

Intra-prediction method exploits one reference tier adjacent to the current prediction unit (PU) and one of the intra-prediction modes to generate the predictors for the current PU. The Intra-prediction direction can be chosen among a mode set containing multiple prediction directions. For each PU coded by Intra-prediction, one index will be used and encoded to select one of the intra-prediction modes. The corresponding prediction will be generated and then the residuals can be derived and transformed.

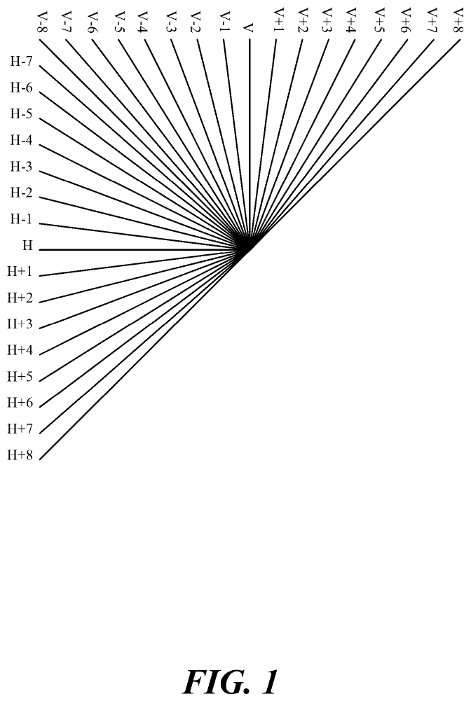

FIG. 1 shows the intra-prediction modes in different directions. These intra-prediction modes are referred to as directional modes and do not include DC mode or Planar mode. As illustrated, there are 33 directional modes (V: vertical direction; H: horizontal direction), so H, H+1˜H+8, H−1˜H−7, V, V+1˜V+8, V−1˜V−8 are used. Generally directional modes can be represented as either as H+k or V+k modes, where k=±1, ±2, . . . , ±8. Each of such intra-prediction mode can also be referred to as an intra-prediction angle. To capture arbitrary edge directions presented in natural video, the number of directional intra modes may be extended from 33, as used in HEVC, to 65 direction modes so that the range of k is from ±1 to ±16. These denser directional intra prediction modes apply for all block sizes and for both luma and chroma intra predictions. By including DC and Planar modes, the number of intra-prediction mode is 35 (or 67).

Out of the 35 (or 67) intra-prediction modes, some modes (e.g., 3 or 5) are identified as a set of most probable modes (MPM) for intra-prediction in current prediction block. The encoder may reduce bit rate by signaling an index to select one of the MPMs instead of an index to select one of the 35 (or 67) intra-prediction modes. For example, the intra-prediction mode used in the left prediction block and the intra-prediction mode used in the above prediction block are used as MPMs. When the intra-prediction modes in two neighboring blocks use the same intra-prediction mode, the intra-prediction mode can be used as an MPM. When only one of the two neighboring blocks is available and coded in directional mode, the two neighboring directions immediately next to this directional mode can be used as MPMs. DC mode and Planar mode are also considered as MPMs to fill the available spots in the MPM set, especially if the above or top neighboring blocks are not available or not coded in intra-prediction, or if the intra-prediction modes in neighboring blocks are not directional modes. If the intra-prediction mode for current prediction block is one of the modes in the MPM set, 1 or 2 bits are used to signal which one it is. Otherwise, the intra-prediction mode of the current block is not the same as any entry in the MPM set, and the current block will be coded as a non-MPM mode. There are all-together 32 such non-MPM modes and a (5-bit) fixed length coding method is applied to signal this mode.

The MPM list is constructed based on intra modes of the left and above neighboring block. Suppose the mode of the left neighboring block is denoted as Left and the mode of the above neighboring block is denoted as Above, and the unified MPM list may be constructed as follows:
When a neighboring block is not available, its intra mode is set to Planar by default.
If both modes Left and Above are non-angular modes:
   MPM list→{Planar, DC, V, H, V−4, V+4}
If one of modes Left and Above is angular mode, and the other is non-angular:
   Set a mode Max as the larger mode in Left and Above
   MPM list→{Planar, Max, Max−1, Max+1, Max−2, Max+2}
If Left and Above are both angular and they are different:
   Set a mode Max as the larger mode in Left and Above
   Set a mode Min as the smaller mode in Left and Above
   If Max-Min is equal to 1:
      MPM list→{Planar, Left, Above, Min−1, Max+1, Min−2}
   Otherwise, if Max-Min is greater than or equal to 62:
      MPM list→{Planar, Left, Above, Min+1, Max−1, Min+2}
   Otherwise, if Max-Min is equal to 2:
      MPM list→{Planar, Left, Above, Min+1, Min−1, Max+1}
   Otherwise:
      MPM list→{Planar, Left, Above, Min−1, Min+1, Max−1}
If Left and Above are both angular and they are the same:
   MPM list→{Planar, Left, Left−1, Left+1, Left−2, Left+2}

Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indices, which are remapped to indices of wide angular modes after parsing.

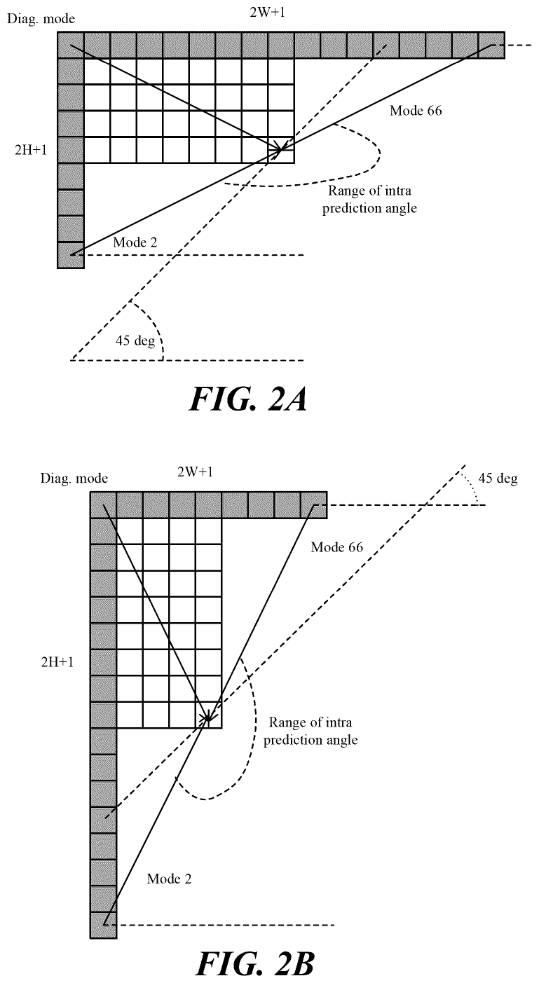

For some embodiments, the total number of intra prediction modes is unchanged, i.e., 67, and the intra mode coding method is unchanged. To support these prediction directions, a top reference template with length 2 W+1 and a left reference template with length 2H+1 are defined. FIGS. 2A-B conceptually illustrate top and left reference templates with extended lengths for supporting wide-angular direction mode for non-square blocks of different aspect ratios.

The number of replaced modes in wide-angular direction mode depends on the aspect ratio of a block. The replaced intra prediction modes for different blocks of different aspect ratios are shown in Table 1 below.

TABLE 1
Intra prediction modes replaced by wide-angular modes

| Aspect ratio | Replaced intra prediction modes |
|---|---|
| W/H == 16 | Modes 2, 3, 4, 5, 6, 7, 8, 9, 10, 11, 12, 13, 14, 15 |
| W/H == 8 | Modes 2, 3, 4, 5, 6, 7, 8, 9, 10, 11, 12, 13 |
| W/H == 4 | Modes 2, 3, 4, 5, 6, 7, 8, 9, 10, 11 |
| W/H == 2 | Modes 2, 3, 4, 5, 6, 7, 8, 9 |
| W/H == 1 | None |
| W/H == ½ | Modes 59, 60, 61, 62, 63, 64, 65, 66 |
| W/H == ¼ | Modes 57, 58, 59, 60, 61, 62, 63, 64, 65, 66 |
| W/H == ⅛ | Modes 55, 56, 57, 58, 59, 60, 61, 62, 63, 64, 65, 66 |
| W/H == 1/16 | Modes 53, 54, 55, 56, 57, 58, 59, 60, 61, 62, 63, 64, |
| | 65, 66 |

II. Reference Sample Smoothing with Interpolation Filter

In some embodiments, four-tap intra interpolation filters may be utilized to improve the directional intra prediction (i.e., excluding Planar and DC predictors) accuracy. In HEVC, a two-tap linear interpolation filter has been used to generate the intra prediction block in the directional prediction modes. In VVC, the two sets of 4-tap IFs replace lower precision linear interpolation as in HEVC, where one is a DCT-based interpolation filter (DCTIF) and the other one is a 4-tap smoothing interpolation filter (SIF). The DCTIF is constructed in the same way as the one used for chroma component motion compensation in both HEVC and VVC. The SIF is obtained by convolving the 2-tap linear interpolation filter with [1 2 1]/4 filter.

Depending on the intra prediction mode, the following reference samples processing may be performed. The directional intra-prediction mode is classified into one of the following groups:
Group A: vertical or horizontal modes (HOR_IDX, VER_IDX),
Group B: directional modes that represent non-fractional angles (−14, −12, −10, −6, 2, 34, 66, 72, 76, 78, 80) and Planar mode,
Group C: remaining directional modes.

If the directional intra-prediction mode is classified as belonging to group A, then no filters are applied to reference samples to generate the predicted samples. Otherwise, if a mode falls into group B and the mode is a directional mode, and certain conditions are all true (e.g., refIdx is equal to 0 or no MRL, TU size is greater than 32, Luma, No ISP block), then a [1, 2, 1] reference sample filter may be applied (depending on the MDIS condition) to reference samples to further copy these filtered values into an intra predictor according to the selected direction, but no interpolation filters are applied. Otherwise, if a mode is classified as belonging to group C, MRL index is equal to 0, and the current block is not ISP block, then only an intra reference sample interpolation filter is applied to reference samples to generate a predicted sample that falls into a fractional or integer position between reference samples according to a selected direction (no reference sample filtering is performed). The interpolation filter type is determined as follows:
Set minDistVerHor equal to Min(Abs(predModeIntra−50), Abs(predModeIntra−18))

$$Set nTbS equal to ( Log 2 ( W ) + Log 2 ( H ) ) ≫ 1$$

Set intraHorVerDistThres[nTbS] as specified below:

| | nTbS = 2 | nTbS = 3 | nTbS = 4 | nTbS =5 | nTbS = 6 | nTbS = 7 |
|---|---|---|---|---|---|---|
| intraHorVerDistThres[ nTbS ] | 24 | 14 | 2 | 0 | 0 | 0 |

If minDistVerHor is greater than intraHorVerDistThres[nTbS], SIF is used for the interpolation
Otherwise, DCTIF is used for the interpolation

### III. Intra-Prediction Based on Additional Reference Lines

When generating intra prediction for the current block, a video coder may use neighboring reconstructed samples of the current block located at one adjacent top reference line (top line 0) section and/or one adjacent left reference line (left line 0) section, or samples located at one non-adjacent top reference line (e.g. top line n where n>0) and one non-adjacent left reference line (e.g. left line m, where m>0 and m=n) as reference samples. In some embodiments of the disclosure, the video coder uses more than one reference lines (which may include more than one left reference line sections and/or more than one top reference line sections) to generate the predicted samples of the current block.

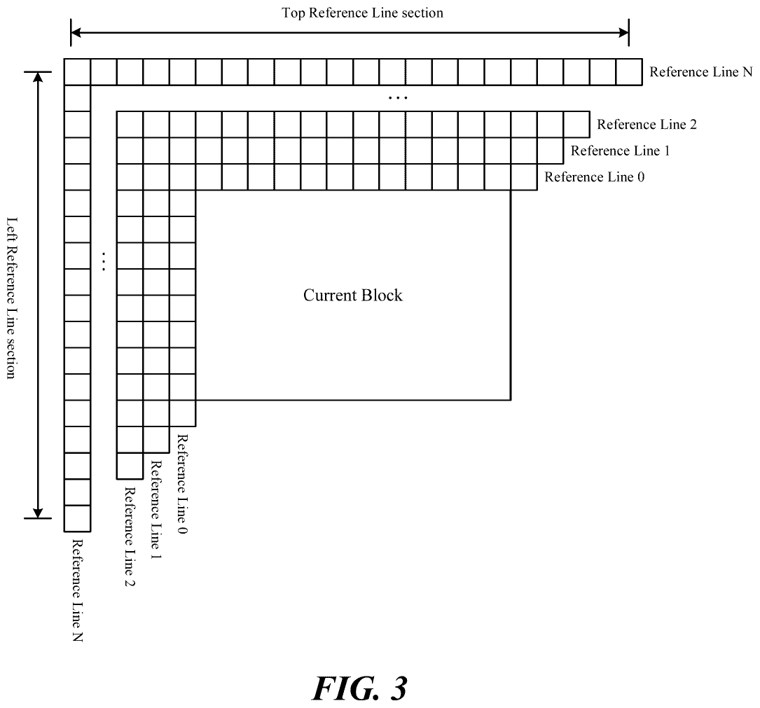

FIG. 3 conceptually illustrates reference lines of a current block that can be used for intra prediction of the current block. The figure illustrates a current block 300 and samples neighboring the current block 300. The neighboring samples to the top and the right are used as reference samples for intra-prediction. The reference samples are grouped into multiple reference lines 0 through N. Reference line 0 is the one closest to the current block and is adjacent to the current block 300. Reference lines 1 through N are non-adjacent reference lines. Each reference line includes a top reference line section and a left reference line section. When a reference line is used for intra prediction, the reference samples in the reference line (whether in top or left reference line section) are used as reference to generate the prediction samples.

In some embodiments, whether to use more than one reference lines to generate intra-prediction samples is determined by an explicit indication that is coded in a bitstream. In some embodiments, the explicit indication is coded with one or more contexts. In some embodiments, multiple contexts are used and the context selection is dependent on the block's width, height, or area. If the area of the current block is smaller than a pre-defined threshold, one context is used, otherwise, another context is used. In some embodiments, multiple contexts are used and the context selection depends on the neighboring mode information. In some embodiments, if the top and left neighboring blocks are both coded with intra prediction, one context is used. Otherwise, if only one of the top and left neighboring blocks is coded with intra prediction, another context is used.

In some embodiments, in some cases, the explicit indication for whether to use multiple reference lines for intra prediction is not signaled/parsed and is inferred as disabling using more than one reference lines to generate intra-prediction samples. For example, in some embodiments, the video coder disables using multiple top and left reference lines for intra prediction when the area of the current block is smaller than a pre-defined threshold, or when the current block has a longer side that is larger than a predefined threshold multiplied by the shorter side, or when the current block has a longer side that is smaller than a predefined threshold multiplied by the shorter side.

In some embodiments, whether to use multiple reference lines for generating intra prediction samples is determined based on an implicit indication. In some embodiments, the implicit indication depends on the block width, height, or area (of the current block.) For example, if the area of the current block is larger than a pre-defined threshold, the video coder may use multiple top and left reference lines for generating intra prediction of the current block, otherwise the video coder does not use multiple reference lines for generating the prediction. In some embodiments, if most neighboring blocks (e.g., the top and left neighboring blocks) of the current block are coded with inter prediction, the video coder may use multiple reference lines for generating intra prediction of the current block, otherwise the video coder does not use multiple reference lines for generating the intra prediction.

In some embodiments, the implicit indication depends on the intra prediction of the current block. If the intra prediction mode for the current block generates non-integer predicted samples (e.g., the samples located at non-integer position), the video coder may use multiple reference lines for intra prediction. Otherwise, multiple reference lines are not used to generate the prediction of the current block. When the intra prediction mode is not directional (e.g., DC or planar), the location of to-be-blended sample in the first used reference line and the location of corresponding to-be-blended sample in the second used reference line are the same.

In some embodiments, if one or more predicted samples fall upon a fractional or non-integer position between reference samples according to the direction of the intra prediction mode, the video coder may apply an interpolation filter to perform intra-prediction. In some embodiments, if a reference sample in the first and/or the second used reference line is not located at an integer position, the video coder may apply an interpolation filter (instead of nearest neighbor rounding) to generate the to-be-blended sample by using the spatially nearby samples (e.g., in the first and second used reference lines.) The interpolation filters for the first used reference line and the second used reference line can be same or different. For example, the tap-length for the first used reference line may be larger (or smaller) than the tap-length for the second used reference line.

In some embodiments, when the implicit indication specifies that the multiple reference lines are not to be used for generating the intra prediction, only one reference line (may include one top reference line section and one left reference line section) is used. In some embodiments, the video coder always uses multiple reference lines for intra prediction. In some embodiment, whether to use single reference line or multiple reference lines for intra prediction is determined based on the block level syntax control or high-level syntax control (e.g., SPS, PPS, PH, SH, or CTU flag).

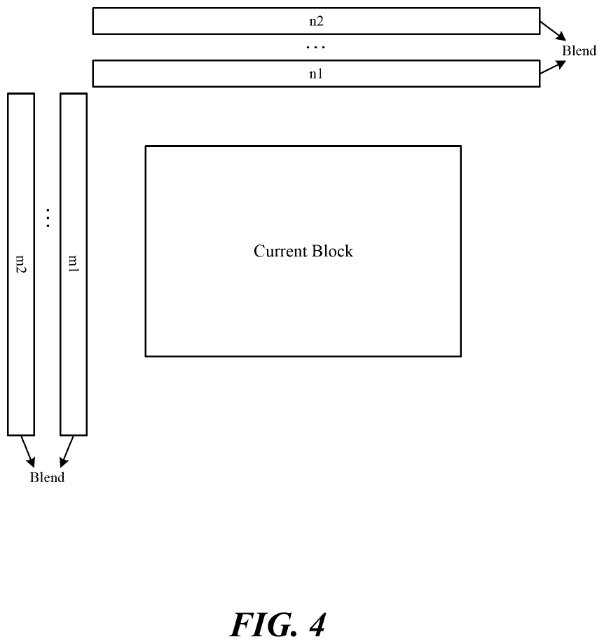

In some embodiments, when multiple reference lines are used for intra prediction of the current block, the reference samples for generating intra prediction include: (i) blended samples of a first used top reference line section (denoted as top line n1) and a second used top reference line section (denoted as top line n2), and (ii) blended samples of the first used left reference line section (denoted as left line m1) and the second used left reference line section (denoted as left line m2). FIG. 4 shows top and left reference line sections that provide samples to be blended for intra prediction, including top reference line sections n1 and n2, and left reference line sections m1 and m2. In some embodiments, n1 and m1 may belong to the same or different reference lines, and n2 and m2 may belong to same or different reference lines. In some embodiments, n1 is different from n2, and m1 is different from m2. The top reference line sections n1 and n2 may belong to reference lines that are adjacent or not adjacent to each other. The left reference line sections m1 and m2 may belong to reference lines that are adjacent or not adjacent to each other. The reference line sections n1, n2, m1, m2 may or may not belong to a reference line that is adjacent to the current block.

In some embodiments, an explicit indication is used to jointly determine n1 and m1 and an implicit indication is used to decide n2 and m2 according to the determined n1 and m1. (Assuming that n1 and m1 belong to the same reference line, and n2 and m2 belong to the same reference line.) The explicit indication for n1 and m1 may be a reference line index referring to top line 0 and left line 0, or the explicit indication for n1 and m1 may be a reference line index referring to a top line non-adjacent to the top boundary of the current block and a left line non-adjacent to the left boundary of the current block. For example, say n2 is inferred as the adjacent line of n1, then index(n2)=index(n1)±1. For another example, say m2 is inferred as the adjacent line of m1, then index(m2)=index(m1)±1. For another example, say n2 is inferred as a non-adjacent line of n1, then index(n2)=index(n1)±k, where k is predefined and k>1. For another example, say m2 is inferred as a non-adjacent line of m1, then index(m2)=index(m1)±k, where k is pre-defined and k>1.

In some embodiments, an explicit indication is used to jointly determine n1 and m1 and another explicit indication is used to jointly determine n2 and m2. (Assuming that n1 and m1 are in the same reference line; and n2 and m2 are in the same reference line.) The explicit indication for n1 and m1 may refer to top line 0 and left line 0 or the explicit indication for n1, and m1 may refer to a top line non-adjacent to the top boundary of the current block and a left line non-adjacent to the left boundary of the current block. For example, the explicit indication for n2 and m2 (denoted as index2) may depend on the explicit indication for n1 and m1 (denoted as index1) (Assume that the maximum number of reference lines is 3), then index(n1)=index1) (ranging from 0 to 2), and index(n2)=index2 (ranging from 0 to 1)+((index2≥index(n1))?1: 0). For another example, the explicit indication for n2 and m2 refers to the difference between the first used reference line and the second used reference line, such that index(n2)=index(n1)±difference, or index(m2)=index(m1)±difference.

In some embodiments, when blending the first used reference line and the second used reference line, a weighting (w1, w2) for the first and second used reference lines is applied. For example, a uniform w1 is applied to each sample in the first used reference line, and a uniform w2 is applied to each sample in the second used reference line. For another example, the weighting (w1, w2) is fixed as (1.5, 0.5) or (3, 1)>>2 is applied after blending. For another example, the weighting (w1, w2) depends on the block width, height, area, or neighboring mode information.

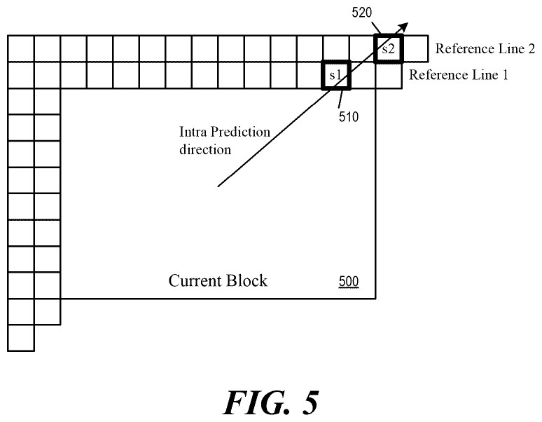

In some embodiments, the blending process is applied to blend each sample in the first used reference line with its collocated sample in the second used reference line. In some embodiments, when blending the first used reference line and the second used reference line, the intra prediction mode of the current block is considered. For example, if the intra prediction mode is directional, the location of to-be-blended sample in first used reference line and the location of corresponding to-be-blended sample in the second used reference line follows the direction of the intra prediction mode. FIG. 5 illustrates blending reference lines based on an intra prediction mode of the current block. In the figure, a reference sample 510 (s1 of reference line 1) is to be blended with a reference sample 520 (s2 of reference line 2) at a location that is identified according to an intra-prediction angle or direction.

In some embodiments, when the intra prediction mode is not directional such as DC or planar, the location of to-be-blended sample in the first used reference line and the collocated location of to-be-blended sample in the second used reference line are the same. In some embodiments, regardless of the intra prediction mode of the current block, the location of to-be-blended sample in the first used reference line and the collocated location of to-be-blended sample in the second used reference line are the same.

In some embodiments, blending the first used reference line and the second used reference line is applied before performing the reference sample smoothing for each used reference line. The video coder may further apply reference sample smoothing or skip reference sample smoothing to the blended reference samples. In some embodiments, the video coder performs blending of the first used reference line with the second used reference line after performing the reference sample smoothing for each used reference line.

In some embodiments, the blended reference samples are stored in an additional memory buffer (different from the buffers storing the first and second used reference lines) to be used for generating the intra prediction of the current block. In some embodiments, the blended reference samples are stored in an existing buffer for either the first or second used reference line to be used for generating intra prediction. That is, if the blended reference samples are stored in the existing buffer for the first used reference line, the blending process can be treated as adding the samples in the second used reference line into the samples in the first used reference line.

In some embodiments, the process for blending the first and second used reference lines is not performed before generating the intra prediction but is performed while generating the intra prediction. Therefore, it is not required to find a buffer to put the blended reference samples in advance. That is, when generating each predicted sample for the current block, the video code accesses not only the reference samples in the first used reference line but also the reference samples in the second used reference line. Weighted averaging is applied when blending the reference samples from the two reference lines. The blended samples are then used as the predicted sample of the current block.

In some embodiments, prior to applying the blending process to a sample (s1) in the first used reference line with its collocated sample (s2) in the second used reference line, a pre-defined criterion is checked. The video coder may apply the blending process to blend s1 and s2 only if the criterion is satisfied. The criterion may be that the difference between s1 and s2 is smaller than a pre-defined threshold, or that the difference between s1 and s2 is larger than a pre-defined threshold.

In some embodiments, using multiple reference lines for intra prediction is not limited to only using two reference lines (the first used reference line and the second used reference line) and can be extended to use more than two reference lines.

The proposed methods in this disclosure can be enabled and/or disabled according to implicit rules (e.g., block width, height, or area) or according to explicit rules (e.g., syntax on block, tile, slice, picture, SPS, or PPS level). The term “block” in this disclosure may refer to TU/TB, CU/CB, PU/PB, pre-defined region, or CTU/CTB. Any combination of the proposed methods in this disclosure can be applied.

Any of the foregoing proposed methods can be implemented in encoders and/or decoders. For example, any of the proposed methods can be implemented in an inter/intra/prediction module of an encoder, and/or an inter/intra/prediction module of a decoder. Alternatively, any of the proposed methods can be implemented as a circuit coupled to the inter/intra/prediction module of the encoder and/or the inter/intra/prediction module of the decoder, so as to provide the information needed by the inter/intra/prediction module.

### IV. Example Video Encoder

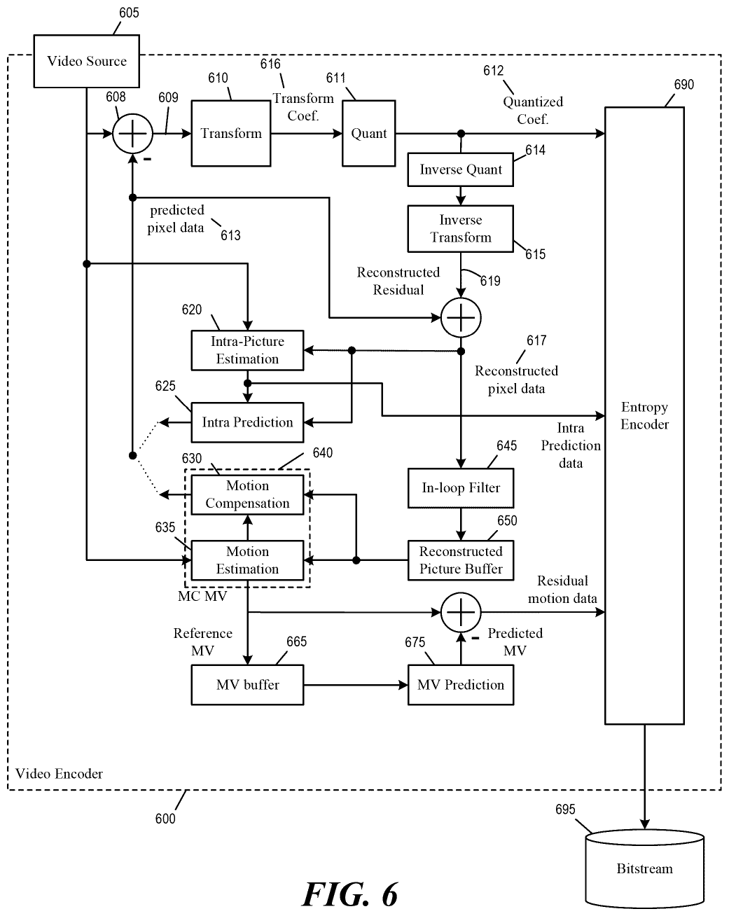

FIG. 6 illustrates an example video encoder 600 that implement intra-prediction. As illustrated, the video encoder 600 receives input video signal from a video source 605 and encodes the signal into bitstream 695. The video encoder 600 has several components or modules for encoding the signal from the video source 605, at least including some components selected from a transform module 610, a quantization module 611, an inverse quantization module 614, an inverse transform module 615, an intra-picture estimation module 620, an intra-prediction module 625, a motion compensation module 630, a motion estimation module 635, an in-loop filter 645, a reconstructed picture buffer 650, a MV buffer 665, and a MV prediction module 675, and an entropy encoder 690. The motion compensation module 630 and the motion estimation module 635 are part of an inter-prediction module 640.

In some embodiments, the modules 610-690 are modules of software instructions being executed by one or more processing units (e.g., a processor) of a computing device or electronic apparatus. In some embodiments, the modules 610-690 are modules of hardware circuits implemented by one or more integrated circuits (ICs) of an electronic apparatus. Though the modules 610-690 are illustrated as being separate modules, some of the modules can be combined into a single module.

The video source 605 provides a raw video signal that presents pixel data of each video frame without compression. A subtractor 608 computes the difference between the raw video pixel data of the video source 605 and the predicted pixel data 613 from the motion compensation module 630 or intra-prediction module 625 as prediction residual 609. The transform module 610 converts the difference (or the residual pixel data or residual signal 608) into transform coefficients (e.g., by performing Discrete Cosine Transform, or DCT). The quantization module 611 quantizes the transform coefficients into quantized data (or quantized coefficients) 612, which is encoded into the bitstream 695 by the entropy encoder 690.

The inverse quantization module 614 de-quantizes the quantized data (or quantized coefficients) 612 to obtain transform coefficients, and the inverse transform module 615 performs inverse transform on the transform coefficients to produce reconstructed residual 619. The reconstructed residual 619 is added with the predicted pixel data 613 to produce reconstructed pixel data 617. In some embodiments, the reconstructed pixel data 617 is temporarily stored in a line buffer (not illustrated) for intra-picture prediction and spatial MV prediction. The reconstructed pixels are filtered by the in-loop filter 645 and stored in the reconstructed picture buffer 650. In some embodiments, the reconstructed picture buffer 650 is a storage external to the video encoder 600. In some embodiments, the reconstructed picture buffer 650 is a storage internal to the video encoder 600.

The intra-picture estimation module 620 performs intra-prediction based on the reconstructed pixel data 617 to produce intra prediction data. The intra-prediction data is provided to the entropy encoder 690 to be encoded into bitstream 695. The intra-prediction data is also used by the intra-prediction module 625 to produce the predicted pixel data 613.

The motion estimation module 635 performs inter-prediction by producing MVs to reference pixel data of previously decoded frames stored in the reconstructed picture buffer 650. These MVs are provided to the motion compensation module 630 to produce predicted pixel data.

Instead of encoding the complete actual MVs in the bitstream, the video encoder 600 uses MV prediction to generate predicted MVs, and the difference between the MVs used for motion compensation and the predicted MVs is encoded as residual motion data and stored in the bitstream 695.

The MV prediction module 675 generates the predicted MVs based on reference MVs that were generated for encoding previously video frames, i.e., the motion compensation MVs that were used to perform motion compensation. The MV prediction module 675 retrieves reference MVs from previous video frames from the MV buffer 665. The video encoder 600 stores the MVs generated for the current video frame in the MV buffer 665 as reference MVs for generating predicted MVs.

The MV prediction module 675 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 695 by the entropy encoder 690.

The entropy encoder 690 encodes various parameters and data into the bitstream 695 by using entropy-coding techniques such as context-adaptive binary arithmetic coding (CABAC) or Huffman encoding. The entropy encoder 690 encodes various header elements, flags, along with the quantized transform coefficients 612, and the residual motion data as syntax elements into the bitstream 695. The bitstream 695 is in turn stored in a storage device or transmitted to a decoder over a communications medium such as a network.

The in-loop filter 645 performs filtering or smoothing operations on the reconstructed pixel data 617 to reduce the artifacts of coding, particularly at boundaries of pixel blocks. In some embodiments, the filtering or smoothing operations performed by the in-loop filter 645 include deblock filter (DBF), sample adaptive offset (SAO), and/or adaptive loop filter (ALF).

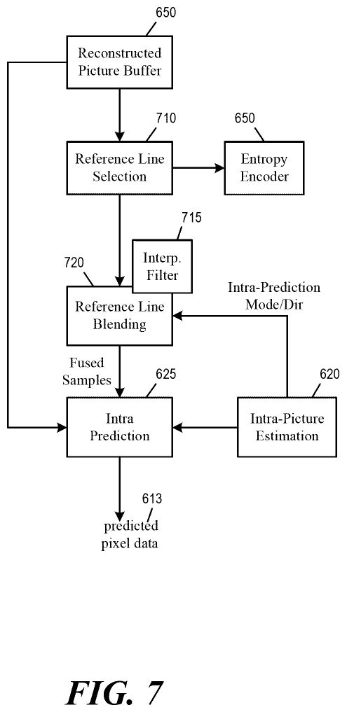

FIG. 7 illustrate portions of the video encoder 600 that implement intra-predictions by blending multiple reference lines. As illustrated in FIG. 7, a reference line selection module 710 selects one or more reference lines. Indications of the selected reference lines are provided to the entropy encoder 690, which may signal one index that represents a combination that includes the selected reference lines, or multiple indices that represent the selected reference lines individually.

Based on the reference line selection, corresponding samples are fetched from the reconstructed picture buffer 650. The fetched samples are provided to a reference line blending module 720, which uses the fetched samples to generate a fused reference line having blended or fused samples.

The intra-picture estimation module 620 specifies an intra-prediction mode for the current block to the reference line blending module 720. The reference line blending module 720 chooses the samples from the different reference line to be blended based on the direction of the intra-prediction mode of the current block. When a samples to be blended is located at non-integer positions due to the intra-prediction mode, an interpolation filter 715 may be applied prior to the samples being blended.

The fused samples of the fused reference line are in turn provided to the intra-prediction module 625, which uses the fused samples and other samples from the reconstructed picture buffer 650 to generate an intra-prediction predictor of the current block as the predicted pixel data 613.

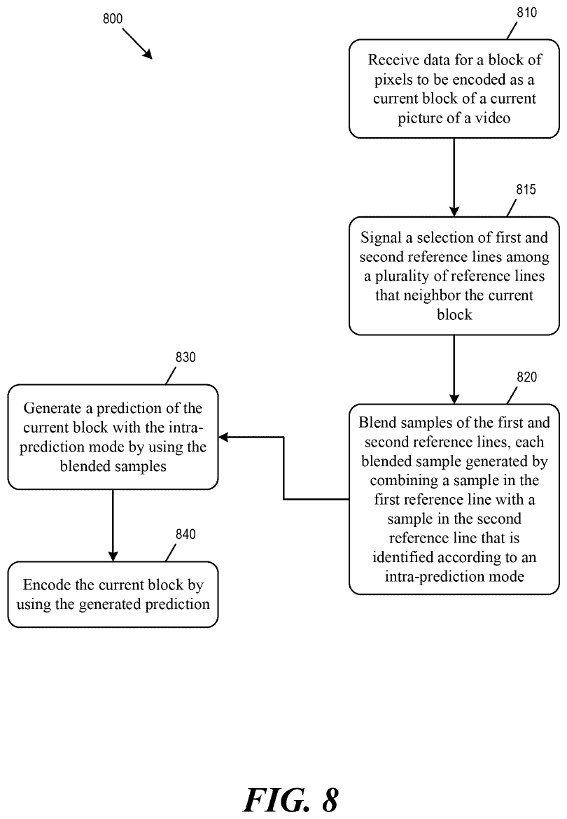

FIG. 8 conceptually illustrates a process 800 that perform intra-prediction by blending multiple reference lines. In some embodiments, one or more processing units (e.g., a processor) of a computing device implementing the encoder 600 performs the process 800 by executing instructions stored in a computer readable medium. In some embodiments, an electronic apparatus implementing the encoder 600 performs the process 800.

The encoder receives (at block 810) data to be encoded as a current block of pixels in a current picture of a video. The encoder signals (at block 815) a selection of first and second reference lines among a plurality of reference lines that neighbor the current block.

The encoder blends (at block 820) samples of the first and second reference lines. Each blended sample is generated by combining a sample in the first reference line with a sample in the second reference line that is identified according to an intra-prediction mode. In some embodiments, when the intra prediction mode is an intra prediction direction, a location of a to-be-blended sample in the first reference line and a location of a to-be-blended sample in the second reference line follow the direction of the intra prediction mode; when the intra prediction mode is not an intra prediction direction, (e.g., DC or planar) a location of a to-be-blended sample in the first reference line and a location of a to-be-blended sample in the second reference line are the same.

In some embodiments, the samples in the first reference line being blended may be samples of a top reference line section (e.g., n1) or a left reference line section (e.g., m1) of the first reference line. The top reference line section (n1) of the first reference line may be identified by a first line index and a top reference line section (n2) of the second reference line may be identified by a second line index. In addition, the left reference line section (m1) of the first reference line may be identified by the first line index and a left reference line section (m2) of the second reference line may be identified by the second line index. In some embodiments, the first reference line index is explicitly signaled and the second reference line index is signaled by an explicitly signaled offset relative to the first line index.

In some embodiments, the encoder may apply an interpolation filter (e.g., 4-tap filter) to a blended sample when the blended sample is located at a non-integer position (e.g., due to the intra-prediction direction). In some embodiments, the encoder applies a first interpolation filter to a sample in the first reference line to be blended (sample-to-be-blended) when the sample is located at a non-integer position. The encoder may also apply a second interpolation filter to a sample in the second reference line to be blended when the sample is located at a non-integer position. The first and second interpolation filters may be same or different (in terms of e.g., filter taps).

The encoder generates (at block 830) a prediction of the current block with the intra-prediction mode by using the blended samples. In some embodiments, the prediction is generated by using the blended sample when an explicit flag enables a particular tool that uses samples from multiple reference lines for intra-prediction. In some embodiments, the prediction is generated by using the blended samples only when an explicit flag enables a particular tool that uses samples from multiple reference lines. In some embodiments, a blended sample is not used to generate the prediction of the current block when a difference between the samples of the first and second reference lines used to create the blended sample fails to meet a particular criterion (e.g., the difference ≥threshold or <threshold.) In some embodiments, whether to blend samples of first and second reference lines is determined based on an implicit indication based on e.g., block width, height, or area of the current block.

The encoder encodes (at block 840) the current block by using the generated prediction to produce prediction residuals.

### V. Example Video Decoder

In some embodiments, an encoder may signal (or generate) one or more syntax element in a bitstream, such that a decoder may parse said one or more syntax element from the bitstream.

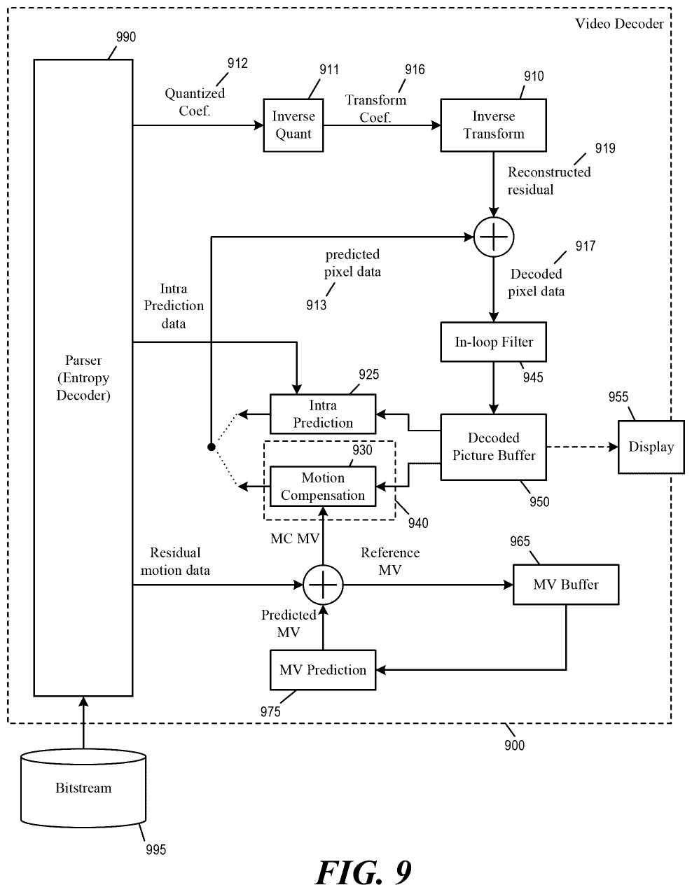

FIG. 9 illustrates an example video decoder 900 that implement intra prediction. As illustrated, the video decoder 900 is an image-decoding or video-decoding circuit that receives a bitstream 995 and decodes the content of the bitstream into pixel data of video frames for display. The video decoder 900 has several components or modules for decoding the bitstream 995, including some components selected from an inverse quantization module 911, an inverse transform module 910, an intra-prediction module 925, a motion compensation module 930, an in-loop filter 945, a decoded picture buffer 950, a MV buffer 965, a MV prediction module 975, and a parser 990. The motion compensation module 930 is part of an inter-prediction module 940.

In some embodiments, the modules 910-990 are modules of software instructions being executed by one or more processing units (e.g., a processor) of a computing device. In some embodiments, the modules 910-990 are modules of hardware circuits implemented by one or more ICs of an electronic apparatus. Though the modules 910-990 are illustrated as being separate modules, some of the modules can be combined into a single module.

The parser 990 (or entropy decoder) receives the bitstream 995 and performs initial parsing according to the syntax defined by a video-coding or image-coding standard. The parsed syntax element includes various header elements, flags, as well as quantized data (or quantized coefficients) 912. The parser 990 parses out the various syntax elements by using entropy-coding techniques such as context-adaptive binary arithmetic coding (CABAC) or Huffman encoding.

The inverse quantization module 911 de-quantizes the quantized data (or quantized coefficients) 912 to obtain transform coefficients, and the inverse transform module 910 performs inverse transform on the transform coefficients 916 to produce reconstructed residual signal 919. The reconstructed residual signal 919 is added with predicted pixel data 913 from the intra-prediction module 925 or the motion compensation module 930 to produce decoded pixel data 917. The decoded pixels data are filtered by the in-loop filter 945 and stored in the decoded picture buffer 950. In some embodiments, the decoded picture buffer 950 is a storage external to the video decoder 900. In some embodiments, the decoded picture buffer 950 is a storage internal to the video decoder 900.

The intra-prediction module 925 receives intra-prediction data from bitstream 995 and according to which, produces the predicted pixel data 913 from the decoded pixel data 917 stored in the decoded picture buffer 950. In some embodiments, the decoded pixel data 917 is also stored in a line buffer (not illustrated) for intra-picture prediction and spatial MV prediction.

In some embodiments, the content of the decoded picture buffer 950 is used for display. A display device 955 either retrieves the content of the decoded picture buffer 950 for display directly, or retrieves the content of the decoded picture buffer to a display buffer. In some embodiments, the display device receives pixel values from the decoded picture buffer 950 through a pixel transport.

The motion compensation module 930 produces predicted pixel data 913 from the decoded pixel data 917 stored in the decoded picture buffer 950 according to motion compensation MVs (MC MVs). These motion compensation MVs are decoded by adding the residual motion data received from the bitstream 995 with predicted MVs received from the MV prediction module 975.

The MV prediction module 975 generates the predicted MVs based on reference MVs that were generated for decoding previous video frames, e.g., the motion compensation MVs that were used to perform motion compensation. The MV prediction module 975 retrieves the reference MVs of previous video frames from the MV buffer 965. The video decoder 900 stores the motion compensation MVs generated for decoding the current video frame in the MV buffer 965 as reference MVs for producing predicted MVs.

The in-loop filter 945 performs filtering or smoothing operations on the decoded pixel data 917 to reduce the artifacts of coding, particularly at boundaries of pixel blocks. In some embodiments, the filtering or smoothing operations performed by the in-loop filter 945 include deblock filter (DBF), sample adaptive offset (SAO), and/or adaptive loop filter (ALF).

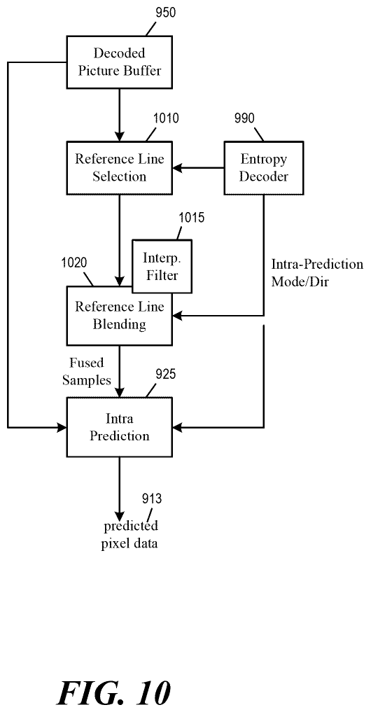

FIG. 10 illustrate portions of the video decoder 900 that implement intra-predictions by blending multiple reference lines. As illustrated in FIG. 10, a reference line selection module 1010 selects one or more reference lines. Indications of the selected reference lines are provided by the entropy decoder 990. The entropy decoder may receive signaling of one index that represents a combination that includes the selected reference lines, or multiple indices that represent the selected reference lines individually.

Based on the reference line selection, corresponding samples are fetched from the decoded picture buffer 950. The fetched samples are provided to a reference line blending module 1020, which uses the fetched samples to generate a fused reference line having blended or fused samples.

The entropy decoder 950 specifies an intra-prediction mode for the current block to the intra prediction module 925 and the reference line blending module 1020. The reference line blending module 1020 chooses the samples from the different reference line to be blended based on the direction of the intra-prediction mode of the current block. When a samples to be blended is located at non-integer positions due to the intra-prediction mode, an interpolation filter 1015 may be applied prior to the samples being blended.

The fused samples of the fused reference line are in turn provided to the intra-prediction module 925, which uses the fused samples and other samples from the decoded picture buffer 950 to generate an intra-prediction predictor of the current block as the predicted pixel data 913.

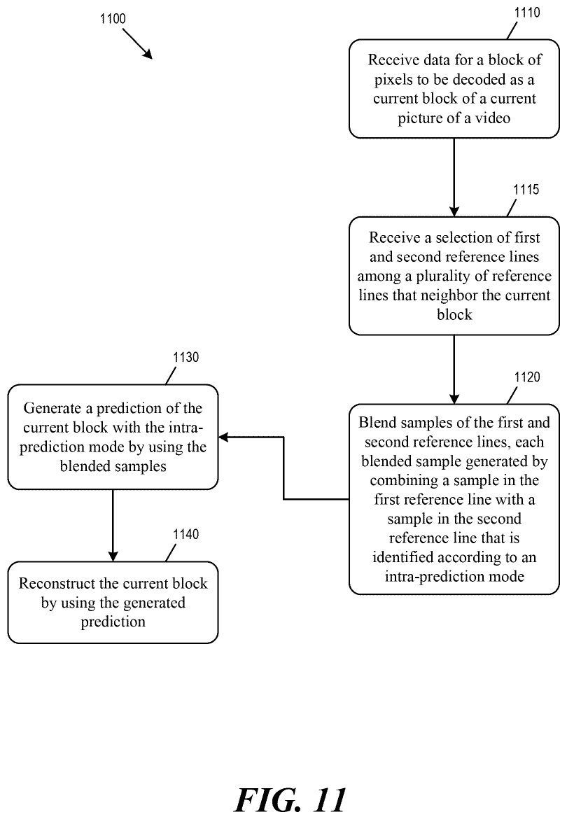

FIG. 11 conceptually illustrates a process 1100 that perform intra-prediction by blending multiple reference lines. In some embodiments, one or more processing units (e.g., a processor) of a computing device implementing the decoder 900 performs the process 1100 by executing instructions stored in a computer readable medium. In some embodiments, an electronic apparatus implementing the decoder 900 performs the process 1100.

The decoder receives (at block 1110) data to be decoded as a current block of pixels in a current picture of a video. The decoder receives (at block 1115) a selection of first and second reference lines among a plurality of reference lines that neighbor the current block.

The decoder blends (at block 1120) samples of the first and second reference lines. Each blended sample is generated by combining a sample in the first reference line with a sample in the second reference line that is identified according to an intra-prediction mode. In some embodiments, when the intra prediction mode is an intra prediction direction, a location of a to-be-blended sample in the first reference line and a location of a to-be-blended sample in the second reference line follow the direction of the intra prediction mode; when the intra prediction mode is not an intra prediction direction, (e.g., DC or planar) a location of a to-be-blended sample in the first reference line and a location of a to-be-blended sample in the second reference line are the same.

In some embodiments, the samples in the first reference line being blended may be samples of a top reference line section (e.g., n1) or a left reference line section (e.g., m1) of the first reference line. The top reference line section (n1) of the first reference line may be identified by a first line index and a top reference line section (n2) of the second reference line may be identified by a second line index. In addition, the left reference line section (m1) of the first reference line may be identified by the first line index and a left reference line section (m2) of the second reference line may be identified by the second line index. In some embodiments, the first reference line index is explicitly signaled and the second reference line index is signaled by an explicitly signaled offset relative to the first line index.

In some embodiments, the decoder may apply an interpolation filter (e.g., 4-tap filter) to a blended sample when the blended sample is located at a non-integer position (e.g., due to the intra-prediction direction). In some embodiments, the decoder applies a first interpolation filter to a sample in the first reference line to be blended (sample-to-be-blended) when the sample is located at a non-integer position. The decoder may also apply a second interpolation filter to a sample in the second reference line to be blended when the sample is located at a non-integer position. The first and second interpolation filters may be same or different (in terms of e.g., filter taps).

The decoder generates (at block 1130) a prediction of the current block with the intra-prediction mode by using the blended samples. In some embodiments, the prediction is generated by using the blended sample when an explicit flag enables a particular tool that uses samples from multiple reference lines for intra-prediction. In some embodiments, the prediction is generated by using the blended samples only when an explicit flag enables a particular tool that uses samples from multiple reference lines. In some embodiments, a blended sample is not used to generate the prediction of the current block when a difference between the samples of the first and second reference lines used to create the blended sample fails to meet a particular criterion (e.g., the difference ≥threshold or <threshold.) In some embodiments, whether to blend samples of first and second reference lines is determined based on an implicit indication based on e.g., block width, height, or area of the current block.

The decoder reconstructs (at block 1140) the current block by using the generated prediction to produce prediction residuals. The decoder may then provide the reconstructed current block for display as part of the reconstructed current picture.

### V. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

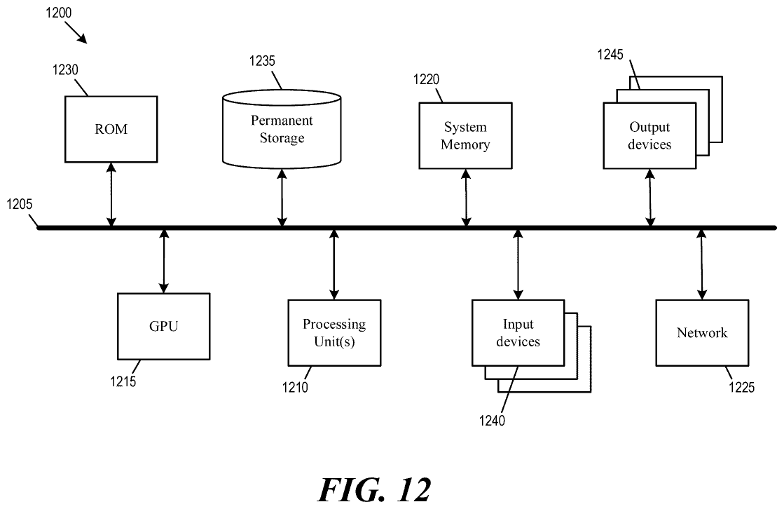

FIG. 12 conceptually illustrates an electronic system 1200 with which some embodiments of the present disclosure are implemented. The electronic system 1200 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1200 includes a bus 1205, processing unit(s) 1210, a graphics-processing unit (GPU) 1215, a system memory 1220, a network 1225, a read-only memory 1230, a permanent storage device 1235, input devices 1240, and output devices 1245.

The bus 1205 collectively represents all system, peripheral, and chipset buses that communicatively connect the numerous internal devices of the electronic system 1200. For instance, the bus 1205 communicatively connects the processing unit(s) 1210 with the GPU 1215, the read-only memory 1230, the system memory 1220, and the permanent storage device 1235.

From these various memory units, the processing unit(s) 1210 retrieves instructions to execute and data to process in order to execute the processes of the present disclosure. The processing unit(s) may be a single processor or a multi-core processor in different embodiments. Some instructions are passed to and executed by the GPU 1215. The GPU 1215 can offload various computations or complement the image processing provided by the processing unit(s) 1210.

The read-only-memory (ROM) 1230 stores static data and instructions that are used by the processing unit(s) 1210 and other modules of the electronic system. The permanent storage device 1235, on the other hand, is a read-and-write memory device. This device is a non-volatile memory unit that stores instructions and data even when the electronic system 1200 is off. Some embodiments of the present disclosure use a mass-storage device (such as a magnetic or optical disk and its corresponding disk drive) as the permanent storage device 1235.

Other embodiments use a removable storage device (such as a floppy disk, flash memory device, etc., and its corresponding disk drive) as the permanent storage device. Like the permanent storage device 1235, the system memory 1220 is a read-and-write memory device. However, unlike storage device 1235, the system memory 1220 is a volatile read-and-write memory, such a random access memory. The system memory 1220 stores some of the instructions and data that the processor uses at runtime. In some embodiments, processes in accordance with the present disclosure are stored in the system memory 1220, the permanent storage device 1235, and/or the read-only memory 1230. For example, the various memory units include instructions for processing multimedia clips in accordance with some embodiments. From these various memory units, the processing unit(s) 1210 retrieves instructions to execute and data to process in order to execute the processes of some embodiments.

The bus 1205 also connects to the input and output devices 1240 and 1245. The input devices 1240 enable the user to communicate information and select commands to the electronic system. The input devices 1240 include alphanumeric keyboards and pointing devices (also called “cursor control devices”), cameras (e.g., webcams), microphones or similar devices for receiving voice commands, etc. The output devices 1245 display images generated by the electronic system or otherwise output data. The output devices 1245 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 12, bus 1205 also couples electronic system 1200 to a network 1225 through a network adapter (not shown). In this manner, the computer can be a part of a network of computers (such as a local area network (“LAN”), a wide area network (“WAN”), or an Intranet, or a network of networks, such as the Internet. Any or all components of electronic system 1200 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 8 and FIG. 11) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically matcable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video coding method comprising:
receiving data for a block of pixels to be encoded or decoded as a current block of a current picture of a video;
receiving or signaling a selection of first and second reference lines among a plurality of reference lines that neighbor the current block;
blending samples of the first and second reference lines, each blended sample generated by combining a sample in the first reference line with a sample in the second reference line that is identified according to an intra-prediction mode;
generating a prediction of the current block with the intra-prediction mode by using the blended samples; and
encoding or decoding the current block by using the generated prediction.

2. The video coding method of claim 1, wherein the samples in the first reference line being blended are samples of a top reference line section or a left reference line section of the first reference line.

3. The video coding method of claim 2, wherein the top reference line section of the first reference line is identified by a first line index and a top reference line section of the second reference line is identified by a second line index, wherein the first reference line index is explicitly signaled and the second reference line index is signaled by an explicitly signaled offset relative to the first line index.

4. The video coding method of claim 3, wherein the left reference line section of the first reference line is identified by the first line index and a left reference line section of the second reference line is identified by the second line index.

5. The video coding method of claim 1, further comprising applying an interpolation filter to a blended sample when the blended sample is located at a non-integer position.

6. The video coding method of claim 1, further comprising applying a first interpolation filter to a sample in the first reference line to be blended when the sample is located at a non-integer position.

7. The video coding method of claim 6, further comprising applying a second interpolation filter to a sample in the second reference line to be blended when the sample is located at a non-integer position, wherein the first and second interpolation filters are different.

8. The video coding method of claim 1, wherein the prediction is generated by using the blended samples when an explicit flag enables a particular tool that uses the plurality of reference lines for intra-prediction of the current block.

9. The video coding method of claim 1, wherein a blended sample is not used to generate the prediction of the current block when a difference between the samples of the first and second reference lines used to create the blended sample fails to meet a particular criterion.

10. The video coding method of claim 1, further comprising determining whether to blend samples of the first and second reference lines is determined based on an implicit indication.

11. The video coding method of claim 10, wherein the implicit indication depends on a block width, height, or area of the current block.

12. The video coding method of claim 1, wherein when the intra prediction mode is not an intra prediction direction, a location of a to-be-blended sample in the first reference line and a location of a to-be-blended sample in the second reference line are the same.

13. The video coding method of claim 1, wherein when the intra prediction mode is an intra prediction direction, a location of a to-be-blended sample in the first reference line and a location of a to-be-blended sample in the second reference line follow the direction of the intra prediction mode.

14. An electronic apparatus comprising:
a video coder circuit configured to perform operations comprising:
receiving data for a block of pixels to be encoded or decoded as a current block of a current picture of a video;
receiving or signaling a selection of first and second reference lines among a plurality of reference lines that neighbor the current block;
blending samples of the first and second reference lines, each blended sample generated by combining a sample in the first reference line with a sample in the second reference line that is identified according to an intra-prediction mode;
generating a prediction of the current block with the intra-prediction mode by using the blended samples; and
encoding or decoding the current block by using the generated prediction.

15. A video decoding method comprising:
receiving data for a block of pixels to be decoded as a current block of a current picture of a video;
receiving a selection of first and second reference lines among a plurality of reference lines that neighbor the current block;
blending samples of the first and second reference lines, each blended sample generated by combining a sample in the first reference line with a sample in the second reference line that is identified according to an intra-prediction mode;
generating a prediction of the current block with the intra-prediction mode by using the blended samples; and
reconstructing the current block by using the generated prediction.

16. A video encoding method comprising:
receiving data for a block of pixels to be encoded as a current block of a current picture of a video;
signaling a selection of first and second reference lines among a plurality of reference lines that neighbor the current block;
blending samples of the first and second reference lines, each blended sample generated by combining a sample in the first reference line with a sample in the second reference line that is identified according to an intra-prediction mode;
generating a prediction of the current block with the intra-prediction mode by using the blended samples; and
encoding the current block by using the generated prediction.
